(19) United States
(12) Patent Application Publication
(10) Pub. No.: US 2010/0084858 A1
(43) Pub. Date: Apr. 8, 2010

(54) HOSE STRUCTURE HAVING A ROTATING UNIT

(76) Inventor: Dong Kil Park, Tokyo (JP)

Correspondence Address: DUANE MORRIS LLP - Atlanta;IP DEPARTMENT, ATLANTIC CENTER PLAZA, 1180 WEST PEACHTREE STREET, NW SUITE 700, ATLANTA, GA, 30309-3348, US

(21) Appl. No.: 12/417,386

(22) Filed: Apr. 2, 2009

Related U.S. Application Data
(60) Provisional application No. 61/103,610, filed on Oct. 8, 2008.

(51) Int. Cl. F16L 33/16; F16L 33/28

(52) U.S. Cl. 285/148.15; 285/247

(57) ABSTRACT

Hose structures having a rotating unit that rotates a fixture are provided. In this regard, a representative hose structure, among others, includes a tube, a rotating unit, and a fixture. The fixture directs fluid and is attached to an end of the tube. The rotating unit connects the end of the tube to the fixture. The rotating unit includes a male connector that inserts into the tube. The male connector includes a borehole that enables fluid to pass through to the fixture. The male connector further includes an extending member that radially extends outward. The rotating unit further includes a ring that is placed between the fixture and the extending member. The ring is designed to rotate on the extending member enabling the fixture to rotate on the tube.

### CROSS-REFERENCE TO RELATED APPLICATION

This application claims priority to copending U.S. provisional application entitled “Shower Hose,” having Ser. No. 61/103,610, filed on Oct. 8, 2008, which is entirely incorporated herein by reference.

### TECHNICAL FIELD

The present disclosure is generally related to hose structures and, more particularly, is related to a hose structure having a rotating unit that rotates a fixture.

### BACKGROUND

Showerheads are typically connected to a hose such that when the showerhead is moved or twisted about the hose, the hose may break or tear, causing a water leakage. In addition, hotels and other similar establishments are hesitant to install expensive showerheads because the showerheads can be stolen.

### SUMMARY

Hose structures having a rotating unit that rotates a fixture are provided. In this regard, a representative hose structure, among others, includes a tube, a rotating unit, and a fixture. The fixture directs fluid and is attached to an end of the tube. The rotating unit connects the end of the tube to the fixture. The rotating unit includes a male connector that inserts into the tube. The male connector includes a borehole that enables fluid to pass through to the fixture. The male connector further includes an extending member that radially extends outward. The rotating unit further includes a ring that is placed between the fixture and the extending member. The ring is designed to rotate on the extending member enabling the fixture to rotate on the tube.

Other structures, apparatuses, methods, features, and advantages of the present disclosure will be or become apparent to one with skill in the art upon examination of the following drawings and detailed description. It is intended that all such additional structures, apparatuses, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a front cross-sectional view that illustrates an embodiment of an assembled hose structure having a rotating unit;

FIG. 2 is a front view that illustrates an embodiment of a hose structure, such as that shown in FIG. 1, being assembled; and

FIG. 3 is a front cross-sectional view that illustrates an embodiment of a pre-assembled hose structure, such as that shown in FIG. 1.

### DETAILED DESCRIPTION

Exemplary hose structures are first discussed with reference to the figures. Although these hose structures are described in detail, they are provided for purposes of illustration only and various modifications are feasible.

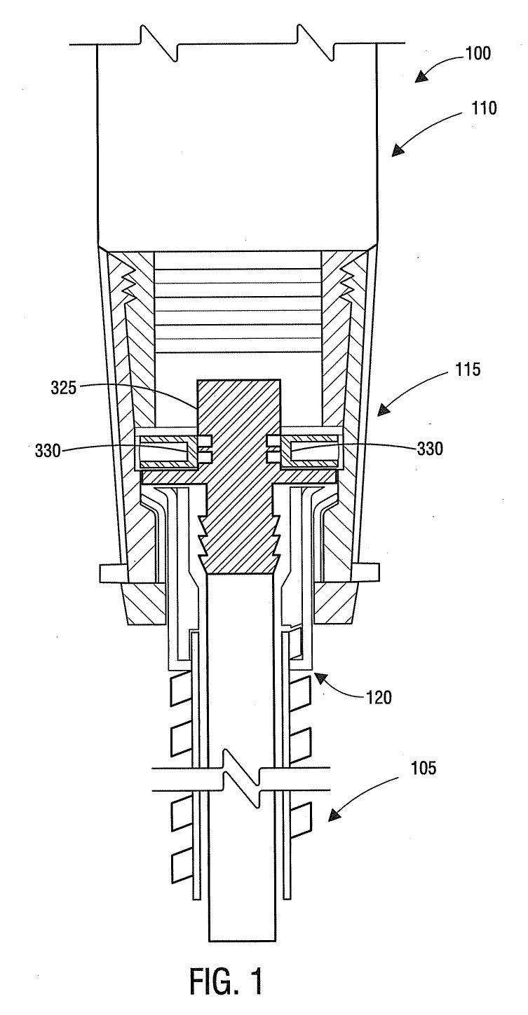

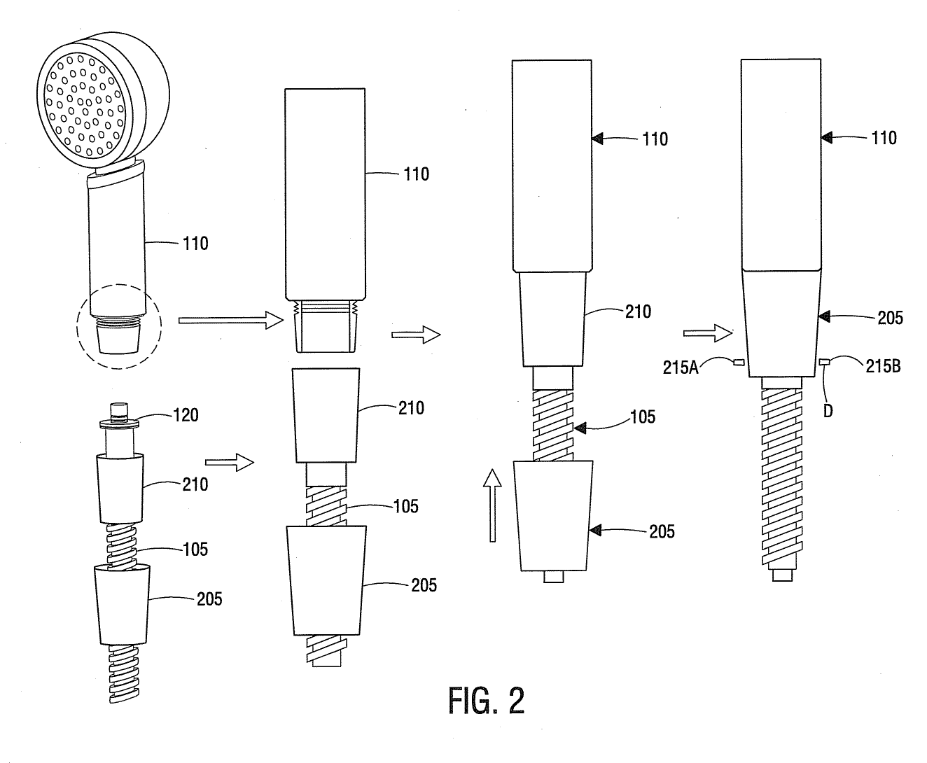

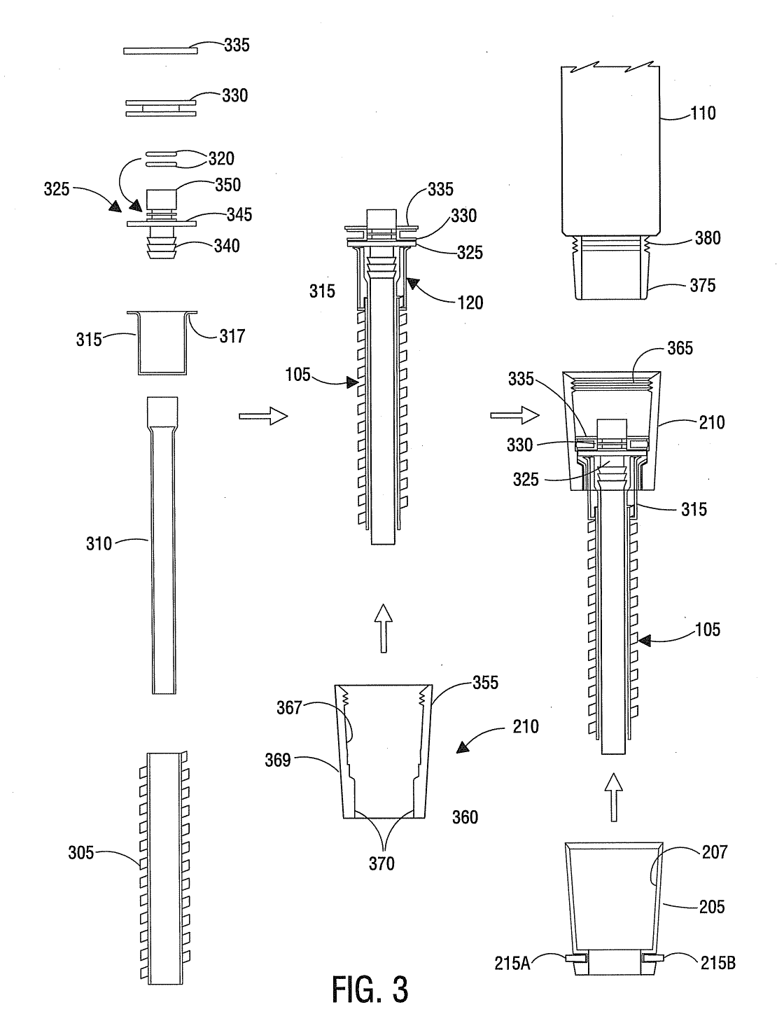

FIG. 1 is a front cross-sectional view that illustrates an embodiment of a hose structure 100 having a rotating unit 115. The hose structure 100 includes a tube 105, a fixture 110, and a rotating unit 115. The tube 105 has an end 120 that connects to the rotating unit 115. The rotating unit 115 couples the end 120 of the tube to the fixture 110, which directs fluid. The rotating unit 115 is further described in relation to FIGS. 2-3.

FIG. 2 is a front view that illustrates an embodiment of a hose structure 100, such as that shown in FIG. 1, being assembled. FIG. 2 illustrates how the hose structure 100 is assembled starting from the left side of FIG. 2 and completing the assembly of the hose structure 100 at the right side of FIG. 2. At the far left of FIG. 2, the rotating unit 115 includes a connection cover 210 and a locking cover 205, both of which are hollowed round housings that taper from one end to another end. It should be noted that some components of the rotating unit 115 has already been assembled into and on the tube 105. These components are further described in relation to FIG. 3.

Prior to assembly these components of the rotating unit 115 into and on the tube, the tube 105 is passed through the hollowed portion of the connection cover 210 and the locking cover 205. The drawings for the hose structure 100 shown on the second far left of FIG. 2 illustrate that the connection cover 210 is positioned at the end 120 of the tube 105 and engages the assembled components of the rotating unit 115 that prevents the connection cover 210 from sliding off the tube 105.

The drawings for the hose structure 100 shown on the second far right of FIG. 2 illustrate that the fixture 110 is screwed on to the connection cover 210 coupling the fixture 110 to the tube 105. The connection cover 210 can rotate with the fixture 110 about the tube 105. The drawings for the hose structure 100 shown on the far right of FIG. 2 illustrate that the locking cover 205 covers and prevents access to the connection cover 210, preventing a user from uncoupling the fixture 110 from the tube 105 by unfastening the fixture 110 from the connection cover 210. The locking cover 205 is placed over the connection cover 210 and is screwed or fastened in place via screws 215A, 215B.

FIG. 3 is a front cross-sectional view that illustrates an embodiment of a pre-assembled hose structure 100, such as that shown in FIG. 1. FIG. 3 illustrates three sets of drawings of the pre-assembled hose structure 100. The drawings of the hose structure 100 on the far left of FIG. 3 show the components of the hose structure 100 that are not assembled. The center drawing of FIG. 3 shows some components of the rotating unit 115 that are assembled into and on the tube 105. The drawings of the hose structure 100 on the far right of FIG. 3 show the connection cover 210 being placed over the assembled components for the rotating unit 115.

In the drawings of the hose structure 100 on the far left of FIG. 3, the tube 105 includes a inner conduit 310 and a outer cover 305. The rotating unit 115 includes protection cover 315, male connector 325, pair of rubber rings 320, ring 330, and second rubber ring 335. In the drawings of the hose structure 100 in the center of FIG. 3, the inner conduit 310 is inserted in the outer cover 305 of the tube 105. The tube protection cover 315 is inserted around the end 120 of the tube 105. The male connector further includes an extending member 345 that radially extends outward. The male connector 325 includes a bottom post 340 that is inserted into the inner conduit 310 and the tube protection cover 315 such that the top ends of tube protection cover 315 and the inner conduit 310 are adjacent to the bottom surface of an extending member 345 of the male connector 325. The male connector 325 includes a borehole that enables fluid to pass through the fixture 110.

The pair of rubber rings 320 is placed above the extending member 345 and in respective grooves on the top post 350 of the male connector 325. The ring 330 is placed between the fixture 110 and extending member 345. The ring 330 is designed to rotate on the extending member 345 enabling the fixture 110 to rotate on the tube 105. The pair of rubber rings 320 is positioned between the male connector 325 and the ring 330. The second rubber ring 335 is placed between the ring 330 and the fixture 110. The pair of rubber rings 320 and the second rubber ring 335 are designed to facilitate preventing the fluid from leaking out of the rotating unit 115.

The tube protection cover 315 covers the end 120 of the tube 105 and a portion of the male connector 325 that is inserted into the tube 105. The connection cover 210 includes internal screw threads 365 at a proximal end 355 of the connection cover 210 and a bulging member 370 at the distal end 360 of the connection cover 210. Both the internal screw threads 365 and the bulging member 370 are placed on an inner surface 367 of the connection cover 210. The proximal end 355 of the connection cover 210 has a greater diameter than the distal end 360 of the connection cover 210. The bulging member 370 is placed adjacent to the bottom surface of the extending member 345. The fixture 110 includes an external screw thread 380 at a distal end 375 of the fixture 110 that screws into the internal screw threads 365 of the connection cover 210.

The tube protection cover 315 includes a flange 317 surrounding the top end of the tube protection cover 315. The flange 317 of the tube protection cover 315 engages the bulging member 370 at the connection cover 210 and the extending member 345. The ring 330 includes a diameter greater than the extending member 345 of the male connector 325.

In the drawings of the hose structure 100 on the far right of FIG. 3, the connection cover 210 is placed over the tube protection cover 315, male connector at 325, pair of rubber rings 320, ring 330, and second rubber ring 335. The fixture 110 is screwed on to internal screw threads 365 of the connection cover 210. The locking cover 205 is shown to be able to slide toward the end 120 of the tube 105. The locking cover 205 covers and prevents access to the connection cover 210. The locking cover 205 includes an inner surface 207 that conforms to the outer surface 369 of the connection cover 210 and the tube protection cover 315. The top end and the bottom end of the locking cover 205 is designed to engage the fixture 110 and the tube protection cover 315, respectively. The locking cover 205 includes at least one fastener 215A, 215B that fastens the locking cover 205 to the connection cover 210.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A hose structure comprising:
a tube having an end;
a rotating unit that connects the end of the tube, the rotating unit including a male connector that inserts into the tube, the male connector including a borehole that enables fluid to pass therethrough, the male connector further including an extending member that radially extends outward, the rotating unit further including a ring that is placed above the extending member; and
a fixture that directs the fluid received from the rotating unit and is coupled to the tube via the rotating unit, the fixture being placed above the ring that is designed to rotate on the extending member enabling the fixture to rotate on the tube.

2. The hose structure as defined in claim 1, wherein the rotating unit further includes a first rubber ring that is placed between the male connector and the ring, the first rubber ring being designed to facilitate preventing the fluid from leaking out of the rotating unit.

3. The hose structure as defined in claim 1, wherein the rotating unit further includes a connection cover that fastens the tube to the fixture and covers from the end of the tube to a distal end of the fixture.

4. The hose structure as defined in claim 3, wherein the connection cover includes internal screw threads at a proximal end of the connection cover and a bulging member at the distal end of the connection cover, both the internal screw threads and the bulging member being placed on an inner surface of the connection cover, the proximal end of the connection cover having a greater diameter than the distal end of the connection cover, the bulging member being placed adjacent to a bottom surface of the extending member, the fixture including an external screw thread at the distal end of the fixture that screws into the internal screw threads of the connection cover.

5. The hose structure as defined in claim 4, wherein the ring includes a diameter greater than the extending member, the connection cover being designed to fasten the fixture onto the rotating unit, the rotating unit being designed to rotate the fixture on the tube.

6. The hose structure as defined in claim 4, wherein the rotating unit further includes a locking cover that covers and prevents access to the connection cover, the locking cover having an inner surface that conforms to an outer surface of the connection cover and a tube protection cover, a top end and bottom end of the locking cover being designed to engage the fixture and the tube protection cover, respectively, the locking cover having at least one fastener that fastens the locking cover to the connection cover.

7. The hose structure as defined in claim 4, wherein the rotating unit further includes a tube protection cover that covers the end of the tube and a portion of the male connector that is inserted into the tube, a top end of the tube protection cover including a flange that is placed between the bulging member of the connection cover and the extending member.

8. The hose structure as defined in claim 1, wherein the rotating unit further includes a second rubber ring that is placed between the ring and the fixture, the second rubber ring being designed to facilitate preventing the fluid from leaking out of the rotating unit.

9. A fixture that receives and directs fluid from a tube comprising:
a rotating unit that connects a bottom end of the fixture, the rotating unit including a male connector that inserts into the tube, the male connector including a borehole that enables the fluid to pass through to the fixture, the male connector further including an extending member that radially extends outward, the rotating unit further including a ring that is placed between the fixture and the extending member, the ring being designed to rotate on the extending member enabling the fixture to rotate on the tube.

10. The fixture as defined in claim 9, wherein the rotating unit further includes a first rubber ring that is placed between the male connector and the ring, the first rubber ring being designed to facilitate preventing the fluid from leaking out of the rotating unit.

11. The fixture as defined in claim 9, wherein the rotating unit further includes a connection cover that connects to the fixture.

12. The fixture as defined in claim 11, wherein the connection cover includes internal screw threads at a proximal end of the connection cover and a bulging member at a distal end of the connection cover, both the internal screw threads and the bulging member being placed on an inner surface of the connection cover, the proximal end of the connection cover having a greater diameter than the distal end of the connection cover, the bulging member being placed adjacent to a bottom surface of the extending member, the fixture including an external screw thread at a distal end of the fixture that screws into the internal screw threads of the connection cover.

13. The fixture as defined in claim 12, wherein the ring includes a diameter greater than the extending member, the connection cover being designed to fasten the fixture onto the rotating unit.

14. The fixture as defined in claim 12, wherein the rotating unit further includes a locking cover that covers and prevents access to the connection cover, the locking cover having an inner surface that conforms to an outer surface of the connection cover and a tube protection cover, a top end and the bottom end of the locking cover being designed to engage the fixture and the tube protection cover, respectively, the locking cover having at least one fastener that fastens the locking cover to the connection cover.

15. The fixture as defined in claim 12, wherein the rotating unit further includes a tube protection cover that covers an end of the tube and a portion of the male connector that is inserted into the tube, a top end of the tube protection cover including a flange that is placed between the bulging member of the connection cover and the extending member.

16. The fixture as defined in claim 9, wherein the rotating unit further includes a second rubber ring that is placed between the ring and the fixture, the second rubber ring being designed to facilitate preventing the fluid from leaking out of the rotating unit.

17. A rotating unit that couples a fixture to a tube, the rotating unit comprising:
a male connector that inserts into the tube, the male connector including a borehole that enables fluid to pass through to the fixture, the male connector further including an extending member that radially extends outward; and
a ring that is placed between the fixture and the extending member, the ring being designed to rotate on the extending member enabling the fixture to rotate on the tube.

18. The rotating unit as defined in claim 17, further comprising a connection cover that connects to the fixture, the connection cover including internal screw threads at a proximal end of the connection cover and a bulging member at a distal end of the connection cover, both the internal screw threads and the bulging member being placed on an inner surface of the connection cover, the proximal end of the connection cover having a greater diameter than the distal end of the connection cover, the bulging member being placed adjacent to a bottom surface of the extending member, the fixture including an external screw thread at a distal end of the fixture that screws into the internal screw threads of the connection cover.

19. The rotating unit as defined in claim 18, further comprising a locking cover that covers and prevents access to the connection cover, the locking cover having an inner surface that conforms to an outer surface of the connection cover and a tube protection cover, a top end and bottom end of the locking cover being designed to engage the fixture and the tube protection cover, respectively, the locking cover having at least one fastener that fastens the locking cover to the connection cover.

20. The rotating unit as defined in claim 18, further comprising a tube protection cover that covers an end of the tube and a portion of the male connector that is inserted into the tube, a top end of the tube protection cover including a flange that is placed between the bulging member of the connection cover and the extending member.
